(19) United States
(12) Patent Application Publication
(10) Pub. No.: US 2021/0062967 A1
(43) Pub. Date: Mar. 4, 2021

(54) ELECTRONIC DEVICE AND ROTATING STRUCTURE

(71) Applicant: CAL-COMP BIG DATA, INC., New Taipei City (TW)

(72) Inventors: Tung-Kai Tsai, New Taipei City (TW); Min-Chang Chi, NEW TAIPEI CITY (TW)

(73) Assignee: CAL-COMP BIG DATA, INC., New Taipei City (TW)

(21) Appl. No.: 16/703,802

(22) Filed: Dec. 4, 2019

(30) Foreign Application Priority Data
Aug. 28, 2019 (CN) 201921410223.X

(51) Int. Cl. F16M 13/02; F16M 11/04; F16M 11/12

(52) U.S. Cl. CPC F16M 13/022; F16M 11/121; F16M 11/041

(57) ABSTRACT

An electronic device includes a device main body, a stand, and a rotating structure including a base body, a first rotating member, and a second rotating member. The base body connected to the device main body has at least one elastic part abutting against the first rotating member. The first rotating member is rotatably connected to the base body along a first rotating axis and is suitable for resisting an elastic force of the elastic part to rotate relative to the base body. The second rotating member is connected to the stand, has at least one friction part, and is rotatably connected to the first rotating member along a second rotating axis. The friction part abuts against the first rotating member, and the second rotating member is suitable for resisting a friction force between the friction part and the first rotating member to rotate relative to the first rotating member.

### CROSS-REFERENCE TO RELATED APPLICATION

This application claims the priority benefit of China application serial no. 201921410223.X, filed on Aug. 28, 2019. The entirety of the above-mentioned patent application is hereby incorporated by reference herein and made a part of this specification.

### BACKGROUND OF THE INVENTION

### 1. Technical Field

The invention relates to an electronic device and a rotating structure and in particular relates to an electronic device with a stand and a rotating structure of the electronic structure.

### 2. Description of Related Art

Handheld electronic devices have been popularized for a long time, wherein smart phones, tablet computers and similar products provide various functions such as communication, photography and multimedia. In terms of a multimedia function, watching films, plays and the like by utilizing handheld electronic devices have become normal use modes of many consumers, and in order to provide convenience for users to watch films by utilizing the handheld electronic devices, many handheld electronic devices have stands for erecting the handheld electronic devices on desktops. However, most stands cannot perform multi-axial rotation relative to device main bodies, and thus there is a lack of freedom in use. Moreover, if frequently-used ordinary hub structures (such as hub structures between host computers and screens of notebook computers) of portable electronic devices are arranged between the stands and the device main bodies in order to solve the problem, the lightweight and thinness characteristics of the handheld electronic devices are lost and the manufacturing and assembling costs are increased due to the complex structures and large sizes of the hub structures.

### SUMMARY OF THE INVENTION

The invention provides an electronic device and a rotating structure, and a stand of the electronic device is capable of performing multi-axial rotation through a simple design.

The electronic device provided by the invention includes a device main body, a stand and a rotating structure. The rotating structure includes a base body, a first rotating member and a second rotating member. The base body is connected to the device main body. The first rotating member is rotatably connected to the base body along a first rotating axis. The first rotating member is suitable for rotating relative to the base body. The second rotating member is connected to the stand and has at least one friction part. The second rotating member is rotatably connected to the first rotating member along a second rotating axis, the friction part abuts against the first rotating member, and the second rotating member is suitable for resisting a friction force between the friction part and the first rotating member so as to rotate relative to the first rotating member.

The rotating structure provided by the invention is suitable for an electronic device, and the electronic device includes a device main body and a stand. The rotating structure includes a base body, a first rotating member and a second rotating member. The base body is connected to the device main body. The first rotating member is rotatably connected to the base body along a first rotating axis. The first rotating member is suitable for rotating relative to the base body. The second rotating member is connected to the stand and has at least one friction part. The second rotating member is rotatably connected to the first rotating member along a second rotating axis, the friction part abuts against the first rotating member, and the second rotating member is suitable for resisting a friction force between the friction part and the first rotating member so as to rotate relative to the first rotating member.

In one embodiment of the invention, the second rotating axis is perpendicular to the first rotating axis.

In one embodiment of the invention, the base body is disposed inside the device main body, and the first rotating member is limited between the base body and the device main body.

In one embodiment of the invention, an accommodating space is formed between the base body and the first rotating member, and the second rotating member is at least partially located in the accommodating space.

In one embodiment of the invention, the base body has at least one elastic part, the at least one elastic part abuts against the first rotating member, and the first rotating member is suitable for resisting an elastic force of the at least one elastic part so as to rotate relative to the base body.

In one embodiment of the invention, the at least one elastic part includes at least one elastic arm.

In one embodiment of the present invention, the base body has at least one open slot, the at least one elastic part is located in the at least one open slot and has a connecting end and a free end which are opposite, the connecting end is connected to an inner edge of the at least one open slot, and the free end abuts against the first rotating member.

In one embodiment of the invention, the at least one elastic part has a convex point and abuts against the first rotating member by the convex point.

In one embodiment of the invention, the second rotating member has at least one rotating shaft part and is rotatably connected to the first rotating member by the at least one rotating shaft part, and the at least one friction part is annular and is sleeved on the at least one rotating shaft part.

In one embodiment of the invention, the first rotating member includes a rotating member main body and at least one rotating shaft cover, the at least one rotating shaft part is rotatably disposed on the rotating member main body, and the at least one rotating shaft cover covers the at least one rotating shaft part and abuts against the at least one friction part.

In one embodiment of the invention, the electronic device includes an antenna, and the antenna is disposed in the stand.

In one embodiment of the invention, the device main body includes a display, and a frame and content displayed by the display is automatically adjusted and rotated related to the display when the device main body is rotated along the first rotating axis to be disposed uprightly or transversely.

Based on the above, in the rotating structure provided by the invention, the base body provides a torque force corresponding to the first rotating axis by virtue of the abutting of the elastic part against the first rotating member, and the second rotating member provides a torque force corresponding to the second rotating axis by virtue of the abutting of the friction part against the first rotating member. Therefore, there is no need to arrange an ordinary hub structure complex in structure and large in size between the device main body and the stand, while the lightweight and thinness characteristics of the electronic device are kept and the manufacturing and assembling costs are reduced by multi-axial rotation of the stand due to the simply-designed rotating structure.

In order to make the aforementioned and other objectives and advantages of the present invention comprehensible, embodiments accompanied with figures are described in detail below.

### BRIEF DESCRIPTION OF THE DRAWINGS

FIG. 1 is a three-dimensional view of an electronic device according to an embodiment of the invention.

FIG. 2 is a three-dimensional view of part of members of the electronic device in FIG. 1.

FIG. 3 is an exploded view of the electronic device in FIG. 2.

FIG. 4 is a further exploded view of the electronic device in FIG. 3.

FIG. 5 illustrates a local structure of the electronic device in FIG. 2.

FIG. 6 is an exploded view of a rotating structure in FIG. 2.

### DESCRIPTION OF THE EMBODIMENTS

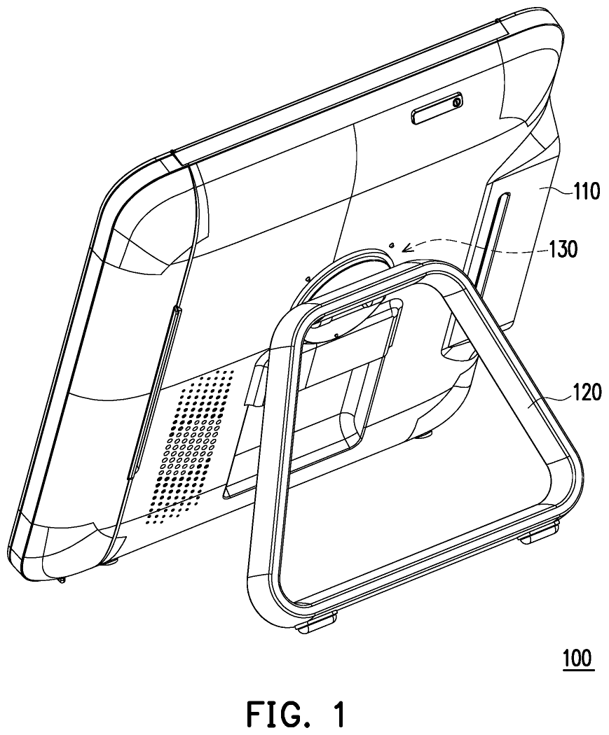

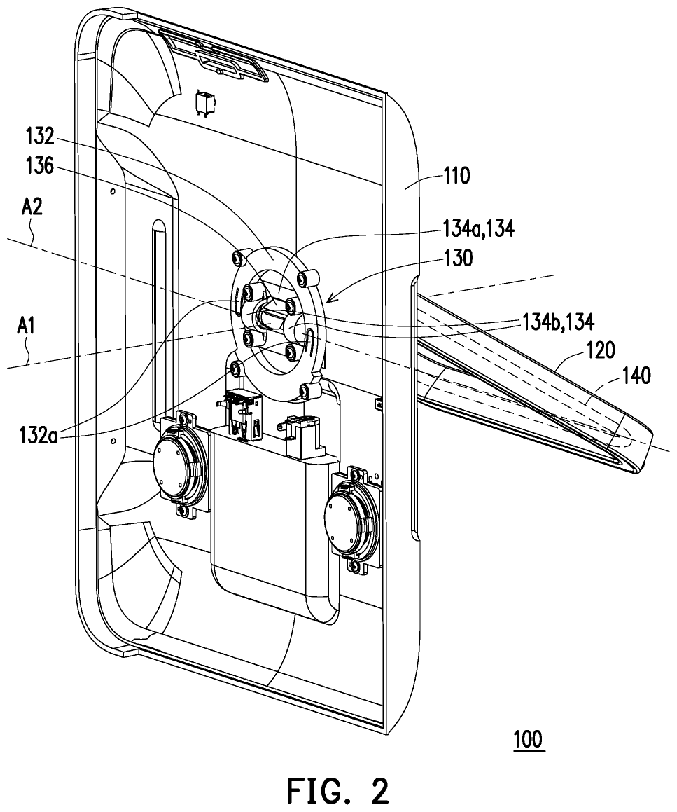

FIG. 1 is a three-dimensional view of an electronic device according to an embodiment of the invention. FIG. 2 is a three-dimensional view of part of members of the electronic device in FIG. 1. Referring to FIG. 1 and FIG. 2, the electronic device 100 in the present embodiment includes a device main body 110, a stand 120 and a rotating structure 130. The device main body 110 is, for example, a tablet computer or any other device of which the function is similar to that of the tablet computer, and the stand 120 is rotatably connected to the reverse side of the device main body 110 by the rotating structure 130. The device main body 110 is supported by the stand 120 so as to be erected on a desktop. In addition, the electronic device 100 include an antenna 140 (shown in FIG. 2) for transceiving signals, and the antenna 140 is disposed in the stand 120 and is electrically connected to the device main body 110 by a circuit of the rotating structure 130. In one embodiment, the antenna 140 is disposed at the lower side inside the stand 120, namely, the overall center of gravity of the stand 120 is downwards moved by virtue of the weight of the antenna 140 to improve the stability during the supporting of the stand 120. In another embodiment, the antenna 140 is designed to be of a linear structure and extends along the shape of the stand so as to be hidden into the stand.

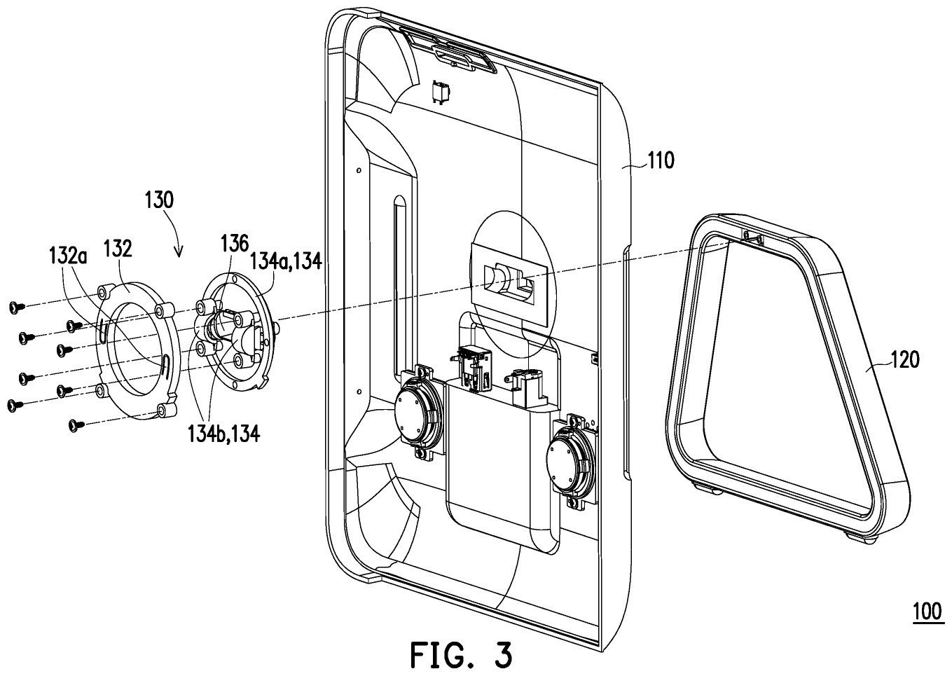

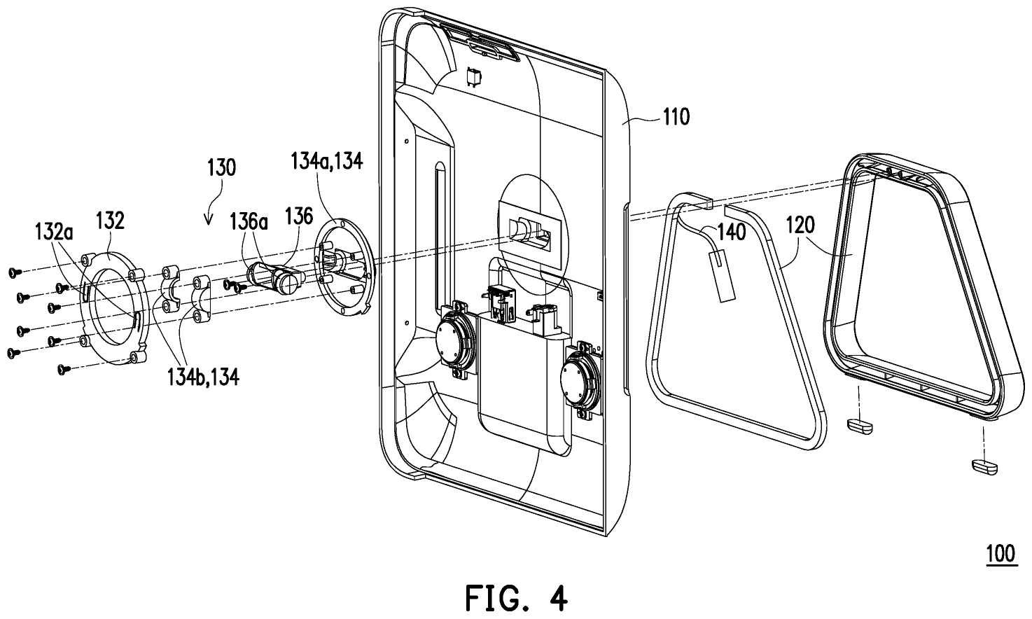

FIG. 3 is an exploded view of the electronic device in FIG. 2. FIG. 4 is a further exploded view of the electronic device in FIG. 3. Referring to FIG. 2 to FIG. 4, the rotating structure 130 in the present embodiment includes a base body 132, a first rotating member 134 and a second rotating member 136. The base body 132 is connected to the device main body 110, for example, in a screw locking way, and the first rotating member 134 is rotatably connected to the base body 132 along a first rotating axis A1 (marked in FIG. 2). The second rotating member 136 is connected to the stand 120, for example, in a screw locking way and is rotatably connected to the first rotating member 134 along a second rotating axis A2 (marked in FIG. 2) perpendicular to the first rotating axis A1. Therefore, the stand 120 is capable of rotating relative to the device main body 110 along the first rotating axis A1 by virtue of the rotation of the first rotating member 134 relative to the base body 132 so that the device main body 110 is transversely or uprightly erected on the desktop. The device main body 110 include a display, and the content displayed by the display is uprightly or transversely placed with rotation of the device main body 110 along the first rotating axis A1 so that a frame is automatically regulated and rotated. Moreover, the stand 120 is capable of rotating relative to the device main body 110 along the second rotating axis A2 by virtue of the rotation of the second rotating member 136 relative to the first rotating member 134, so that the inclination angle of the device main body 110 is regulated.

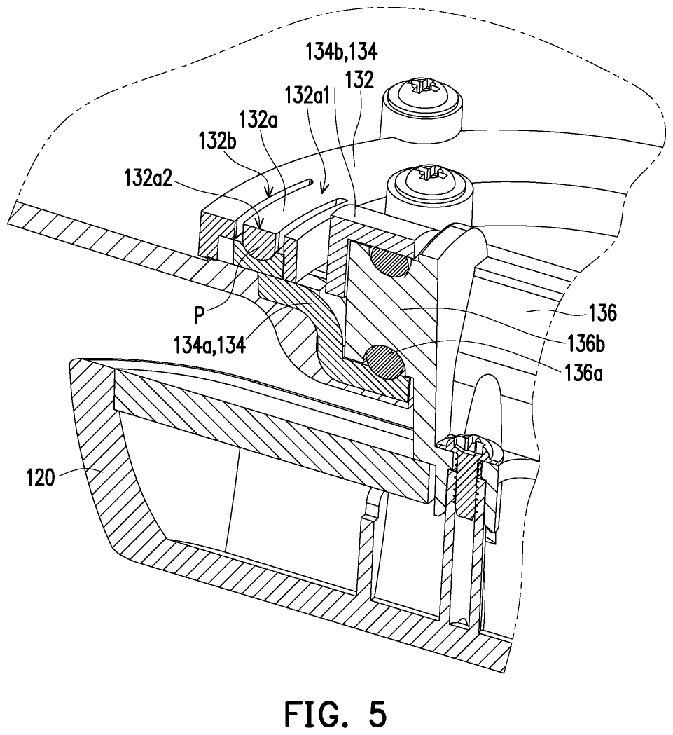

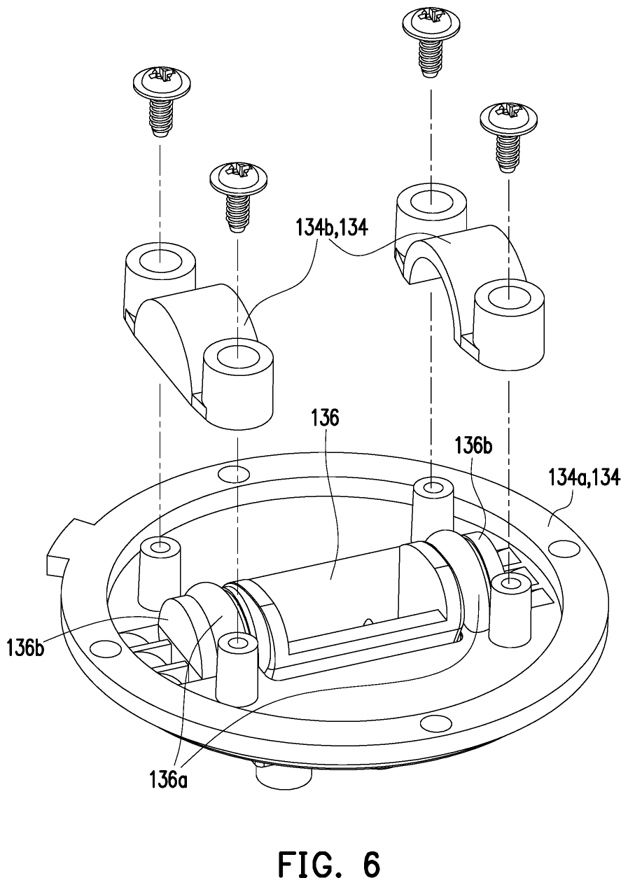

FIG. 5 illustrates a local structure of the electronic device in FIG. 2. Referring to FIG. 2 and FIG. 5, the base body 132 in the present embodiment has at least one elastic part 132a (two as shown in FIG. 2). The elastic parts 132a are, for example, elastic arms and abut against the first rotating member 134, and the first rotating member 134 is suitable for resisting elastic forces of the elastic parts 132a so as to rotate relative to the base body 132 along the first rotating axis A1. FIG. 6 is an exploded view of a rotating structure in FIG. 2. Referring to FIG. 4 to FIG. 6, the second rotating member 136 in the present embodiment has at least one friction part 136a (two as shown). The friction parts 136a are, for example, O-shaped rings and abut against the first rotating member 134, and the second rotating member 136 is suitable for resisting friction forces between the friction parts 136a and the first rotating member 134 so as to rotate relative to the first rotating member 134 along the second rotating axis A2.

Namely, in the present embodiment, the base body 132 provides a torque force corresponding to the first rotating axis A1 by virtue of the abutting of the elastic part 132 against the first rotating member 134, and the second rotating member 136 provides a torque force corresponding to the second rotating axis A2 by virtue of the abutting of the friction parts 136a against the first rotating member 134. Therefore, there is no need to arrange an ordinary hub structure complex in structure and large in size between the device main body 110 and the stand 120, while the lightweight and thinness characteristics of the electronic device 100 are kept and the manufacturing and assembling costs are reduced by multi-axial rotation of the stand 120 due to the simply-designed rotating structure 130.

Furthermore, as shown in FIG. 2 to FIG. 4, the base body 132 in the present embodiment is disposed inside the device main body 110, and the first rotating member 134 is limited between the base body 132 and the device main body 110. Moreover, an accommodating space (such as a circular groove 133 marked in FIG. 2) is formed between the base body 132 and the first rotating member 134, and the second rotating member 136 which is simple in structure and small in size is at least partially located in the accommodating space. Therefore, the rotating structure 130 is hidden into the device main body 110 in a way that the internal disposition space of the device main body 110 is not excessively occupied.

A disposition way of the elastic part 132a of the base body 132 is described below in detail. As shown in FIG. 5, the base body 132 in the present embodiment has an open slot 132b, the elastic part 132a is located in the open slot 132b and has a connecting end 132a1 and a free end 132a2 which are opposite, the connecting end 132a1 is integrally connected to an inner edge of the open slot 132b, the free end 132a2 has a convex point P and abuts against the first rotating member 134 by the convex point P, a friction force is generated between the convex point P and the first rotating member 134 by virtue of the elastic force of the elastic part 132a, and the torque force corresponding to the first rotating axis A1 is provided by virtue of the friction force. In other embodiments, the elastic part 132a is of an elastic structure in any other form and is also disposed in other proper ways, which is not limited in the invention.

A disposition way of the friction part 136a of the second rotating member 136 is described below in detail. As shown in FIG. 5 and FIG. 6, the second rotating member 136 has at least one rotating shaft part 136b (two as shown) and is rotatably connected to the first rotating member 134 by the rotating shaft part 136b, and an annular friction part 136a is disposed in a way of being sleeved on the rotating shaft part 136b. The first rotating member 134 includes a rotating member main body 134a and at least one rotating shaft cover 134b, the rotating shaft part 136b is rotatably disposed on the rotating member main body 134a, and the rotating shaft cover 134b is assembled on the rotating member main body 134a, for example, in a screw locking way to cover the rotating shaft part 136b and abuts against the friction part 136a. The friction part 136a is made of a material such as rubber, silica gel or any other material capable of providing a high friction force. In other embodiments, the friction part 136a is of a friction structure in any other form and is also disposed in other proper ways, which is not limited in the invention.

Based on the above, in the rotating structure provided by the invention, the base body provides a torque force corresponding to the first rotating axis by virtue of the abutting of the elastic parts against the first rotating member, and the second rotating member provides a torque force corresponding to the second rotating axis by virtue of the abutting of the friction part against the first rotating member. Therefore, there is no need to arrange an ordinary hub structure complex in structure and large in size between the device main body and the stand, while the lightweight and thinness characteristics of the electronic device are kept and the manufacturing and assembling costs are reduced by multi-axial rotation of the stand due to the simply-designed rotating structure.

It should be finally noted that the above embodiments are merely intended for describing the technical solutions of the present invention rather than limiting the present invention. Although the present invention is described in detail with reference to the foregoing embodiments, those of ordinary skill in the art should understand that they can still make modifications to the technical solutions described in the foregoing embodiments or make equivalent substitutions to some technical features thereof, without departing from scope of the technical solutions of the embodiments of the present invention.

What is claimed is:

1. An electronic device, comprising:
a device main body;
a stand, and
a rotating structure, comprising:
a base body, connected to the device main body;
a first rotating member, rotatably connected to the base body along a first rotating axis, wherein the first rotating member is suitable for rotating relative to the base body; and
a second rotating member, connected to the stand and having at least one friction part, wherein the second rotating member is rotatably connected to the first rotating member along a second rotating axis, the at least one friction part abuts against the first rotating member, and the second rotating member is suitable for resisting a friction force between the at least one friction part and the first rotating member so as to rotate relative to the first rotating member.

2. The electronic device according to claim 1, wherein the second rotating axis is perpendicular to the first rotating axis.

3. The electronic device according to claim 1, wherein the base body is disposed inside the device main body, and the first rotating member is limited between the base body and the device main body.

4. The electronic device according to claim 1, wherein an accommodating space is formed between the base body and the first rotating member, and the second rotating member is at least partially located in the accommodating space.

5. The electronic device according to claim 1, wherein the base body has at least one elastic part, the at least one elastic part abuts against the first rotating member, and the first rotating member is suitable for resisting an elastic force of the at least one elastic part so as to rotate relative to the base body.

6. The electronic device according to claim 5, wherein the at least one elastic part comprises at least one elastic arm.

7. The electronic device according to claim 5, wherein the base body has at least one open slot, the at least one elastic part is located in the at least one open slot and has a connecting end and a free end which are opposite, the connecting end is connected to an inner edge of the at least one open slot, and the free end abuts against the first rotating member.

8. The electronic device according to claim 1, wherein the second rotating member has at least one rotating shaft part and is rotatably connected to the first rotating member by the at least one rotating shaft part, and the at least one friction part is annular and is sleeved on the at least one rotating shaft part.

9. The electronic device according to claim 8, wherein the first rotating member comprises a rotating member main body and at least one rotating shaft cover, the at least one rotating shaft part is rotatably disposed on the rotating member main body, and the at least one rotating shaft cover covers the at least one rotating shaft part and abuts against the at least one friction part.

10. The electronic device according to claim 1, comprising an antenna, wherein the antenna is disposed in the stand.

11. The electronic device according to claim 1, wherein the device main body comprises a display, and a frame and content displayed by the display is automatically adjusted and rotated related to the display when the device main body is rotated along the first rotating axis to be disposed uprightly or transversely.

12. A rotating structure, being suitable for an electronic device, the electronic device comprising a device main body and a stand, wherein the rotating structure comprises:
a base body, connected to the device main body;
a first rotating member, rotatably connected to the base body along a first rotating axis, wherein the first rotating member is suitable for rotating relative to the base body; and
a second rotating member, connected to the stand and having at least one friction part, wherein the second rotating member is rotatably connected to the first rotating member along a second rotating axis, the at least one friction part abuts against the first rotating member, and the second rotating member is suitable for resisting a friction force between the at least one friction part and the first rotating member so as to rotate relative to the first rotating member.

13. The rotating structure according to claim 12, wherein the second rotating axis is perpendicular to the first rotating axis.

14. The rotating structure according to claim 12, wherein the base body is disposed inside the device main body, and the first rotating member is limited between the base body and the device main body.

15. The rotating structure according to claim 12, wherein an accommodating space is formed between the base body and the first rotating member, and the second rotating member is at least partially located in the accommodating space.

16. The rotating structure according to claim 12, wherein the base body has at least one elastic part, the at least one elastic part abuts against the first rotating member, and the first rotating member is suitable for resisting an elastic force of the at least one elastic part so as to rotate relative to the base body.

17. The rotating structure according to claim 16, wherein the at least one elastic part comprises at least one elastic arm.

18. The rotating structure according to claim 16, wherein the base body has at least one open slot, the at least one elastic part is located in the at least one open slot and has a connecting end and a free end which are opposite, the connecting end is connected to an inner edge of the at least one open slot, and the free end abuts against the first rotating member.

19. The rotating structure according to claim 12, wherein the second rotating member has at least one rotating shaft part and is rotatably connected to the first rotating member by the at least one rotating shaft part, and the at least one friction part is annular and is sleeved on the at least one rotating shaft part.

20. The rotating structure according to claim 19, wherein the first rotating member comprises a rotating member main body and at least one rotating shaft cover, the at least one rotating shaft part is rotatably disposed on the rotating member main body, and the at least one rotating shaft cover covers the at least one rotating shaft part and abuts against the at least one friction part.
